(19) United States
(12) Patent Application Publication
(10) Pub. No.: US 2014/0317180 A1
(43) Pub. Date: Oct. 23, 2014

(54) Method, Device and Central Server for Providing Service for LDAP Client

(71) Applicant: Yaotian Zheng, Beijing (CN)

(72) Inventor: Yaotian Zheng, Beijing (CN)

(73) Assignee: TELEFONAKTIEBOLAGET L M ERICSSON (PUBL), Stockholm (SE)

(21) Appl. No.: 14/354,969

(22) PCT Filed: Nov. 3, 2011
(86) PCT No.: PCT/CN2011/001853

§ 371 Date: Apr. 29, 2014

(51) Int. Cl. H04L 29/08

(52) U.S. Cl. CPC H04L 67/10
USPC 709/203

(57) ABSTRACT

The present invention relates to a device, a method and a central server for providing service to a Lightweight Directory Access Protocol LDAP client from a central server with multiple back-ends. A LDAP request for accessing a service is received from the LDAP client, and the requested service is identified from the LDAP request. One or more back-ends are scheduled to provide service according to a rule predefined for the requested service, which rule indicating which back-end(s) are to be used for the requested service. The scheduled back-end(s) are queried with respective back-end requests according to the rule to obtain back-end responses. A LDAP response based on the obtained back-end responses is formed and is provide to the LDAP client. This allows a central server with multiple back-ends to provide services for LDAP client in a more efficient way.

### TECHNICAL FIELD

The present invention relates generally to the field of Light Directory Access Protocol (LDAP), and particularly to a method, device and central server for providing services for LDAP clients.

### BACKGROUND

In a telecommunication network environment, user accounts for login UNIX servers or Network Elements (NEs) are managed by a central server, which is generally a central authentication and authorization server. Users' information like user account is stored in e.g. a directory server or a relational database. With technological advancement, a directory server or a relational database may be used for different applications, while one application may also use different directory servers or relational databases.

For historical reason, especially for purpose of authentication and authorization, a central server will comprise different types of directory servers or relational databases for servicing different clients. Directory servers and relational databases and the like are collectively called “back-end” hereinafter. Existing back-ends include, for example, LDAP server, RADIUS (Remote Access Dial-in User Service) server, Mysql server, MS SQL Server, Oracle database, DB2, or XML file, etc. Sometimes, one or some of them are used together to function as a central user database for authentication and authorization or other services.

Nowadays, LDAP clients, for example, pam_ldap (LDAP pluggable authentication module) or nss_ldap (LDAP name service switch), are often installed in e.g. UNIX servers or NEs to request services, such as authentication, authorization, password changing, name service etc. from a LDAP server. However, although the central server may have multiple back-ends, LDAP clients can only support connection with LDAP servers, but they can't interact with other back-ends. If UNIX servers or NEs are to use information in other back-ends, they need install clients for respective back-ends. This means every time a new back-end is introduced in a central server, all UNIX servers or NEs that may request services will have to be upgraded to have a corresponding client. All of these may highly increase server management cost and client upgrade cost.

### SUMMARY

An object of the present invention is to provide an improved method, device and central server to obviate at least some of the above-mentioned disadvantages.

According to a first aspect of the present invention, the present invention provides a device for providing service to a Lightweight Directory Access Protocol LDAP client from a central server with multiple back-ends. The device comprises a LDAP interfacing unit, being configured to receive a LDAP request for accessing a service from the LDAP client and provide a LDAP response to the LDAP client; a back-end scheduling unit, being configured to identify the requested service from the LDAP request and schedule one or more back-ends to provide service according to a rule predefined for the requested service, the rule indicating which back-end(s) are to be used for the requested services; and a back-end interfacing unit, being configured to query the scheduled back-end(s) with respective back-end requests according to the rule and obtain back-end responses. The back-end scheduling unit is further configured to form a LDAP response to the LDAP client based on the obtained back-end responses.

This provides a mechanism to connect a LDAP client with different back-ends, since a LDAP request is transformed to respective back-end requests by describing the LDAP request as a service. This also makes the type and number of back-ends in the central server be hidden from the LDAP client, since the back-ends are consolidated and function as a whole, just like a single central user database. As such, a LDAP client can ‘talk’ with different back-ends and utilize user information or other resources from multiple back-ends. Even if back-ends in the central server are changed, there is no need for installing new client or removing old client in UNIX servers or NEs. This substantially reduces cost and effect for adapting to changes of back-ends and enables the central server to provide its services in a more efficient way.

Preferably, the rule is updated to adapt to changes of back-ends in the central server.

This enables to flexibly configure or modify the way that back-ends cooperate in case back-ends change in the central server.

Preferably, the rule further indicates mapping relationships between the requested service and respective back-end requests. Additionally, the back-end interfacing unit generates a back-end request for each scheduled back-end based on the mapping relationships. Alternatively, the rule further indicates operation logics to be followed by the scheduled back-ends.

This allows easily incorporating new type of back-ends with new protocols.

Preferably, the back-end scheduling unit being configured to combine information or remove duplicated information in the obtained back-end responses.

Said multiple back-ends may comprise a LDAP server, a RADIUS server MS SQL Server, Oracle Server, DB2 Server, or XML file.

According to a second aspect of the present invention, the present invention provides a method of providing services for a Lightweight Directory Access Protocol LDAP client from a central server with multiple back-ends. The method comprises the steps of: receiving a LDAP request for accessing a service from the LDAP client, identifying the requested service from the LDAP request, scheduling one or more back-ends to provide service according to a rule predefined for the requested service, the rule indicating which back-end(s) are to be used for the requested service, querying the scheduled back-end(s) with respective back-end requests according to the rule to obtain back-end responses, and forming a LDAP response based on the obtained back-end responses and providing the LDAP response to the LDAP client.

According to a third aspect of the present invention, the present invention provides a central server comprising a device according to the present invention.

According to a fourth aspect of the present invention, the present invention provides a computer program product comprising a computer readable medium having computer readable code thereon, the computer readable code, when loaded in a computer, causing the computer to perform a method according to present invention.

### BRIEF DESCRIPTION OF THE DRAWINGS

The foregoing and other objects, features, and advantages of the present invention will become more apparent from the following description of preferred embodiments and accompany drawings.

FIG. 1 illustrates an example of prior art system for providing services.

FIG. 2 illustrates another example of prior art system for providing services via multiple back-ends.

FIG. 3 illustrates a system in which one embodiment of the present invention is implemented.

FIG. 4 illustrates a block diagram of a virtual LDAP server according to an embodiment of the present invention.

FIG. 5 illustrates an exemplary architecture of a virtual LDAP server according to an embodiment of the present invention.

FIG. 6 illustrates a flow chart of a method according to an embodiment of the present invention.

FIG. 7 illustrates a flow chart of an exemplary method performed by a virtual LDAP server depicted in FIG. 5.

### DETAILED DESCRIPTION

In the following description, for purposes of explanation rather than limitation, specific details, such as the particular architecture, interfaces, techniques, etc., are set forth for illustration. However, it will be apparent to those of ordinary skill in the art that other embodiments that depart from these specific details would still be understood to be within the scope of the present invention. Moreover, for the purpose of clarity, detailed descriptions of well-known device, circuits, and methods are omitted so as not to obscure the description of the present invention. It should be expressly understood that the drawings are included for illustrative purposes and do not represent the scope of the present invention. In the accompanying drawings, like reference numbers in different drawings may designate similar elements.

Hereinafter, descriptions of embodiments of the present invention are provided in detail with reference to the drawings.

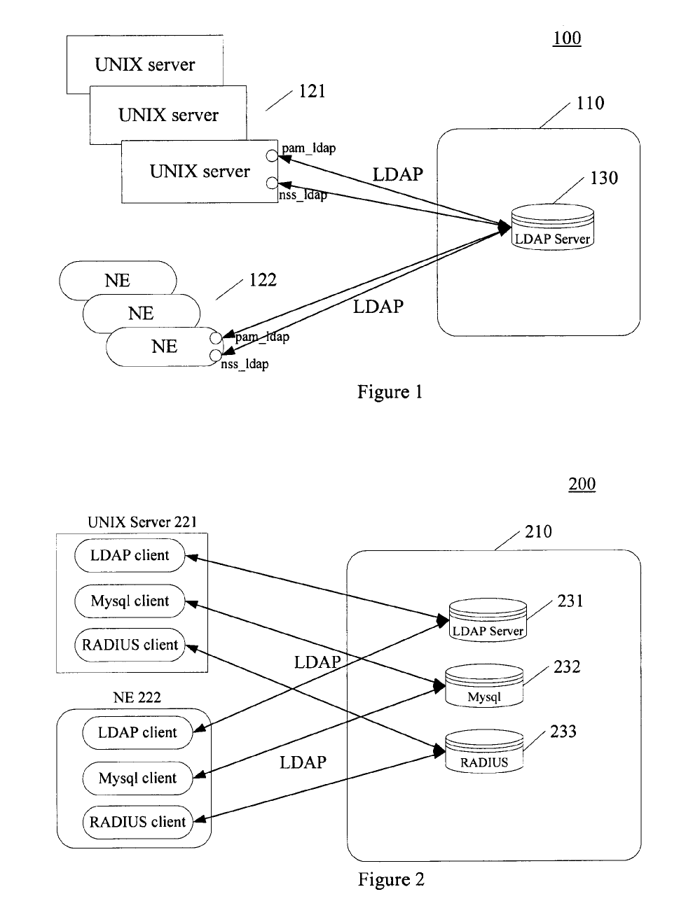

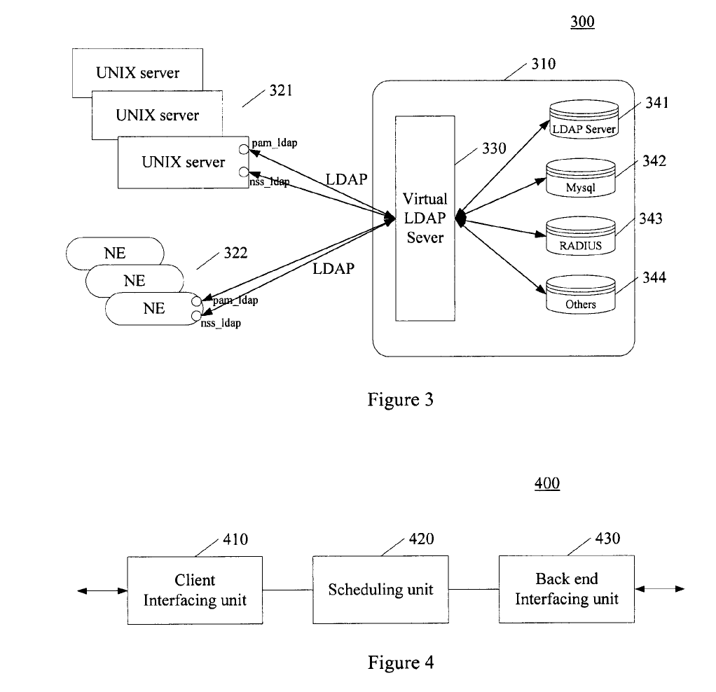

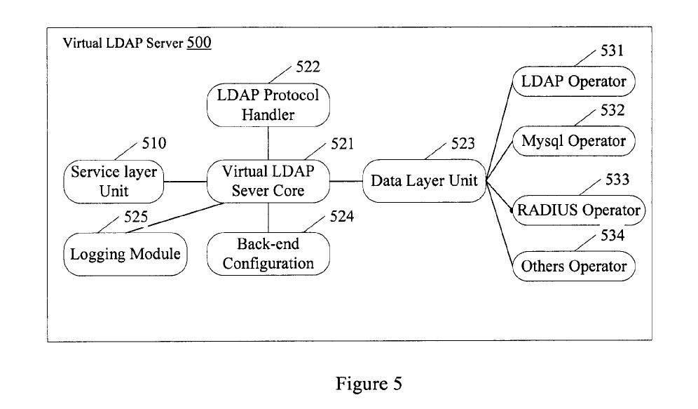

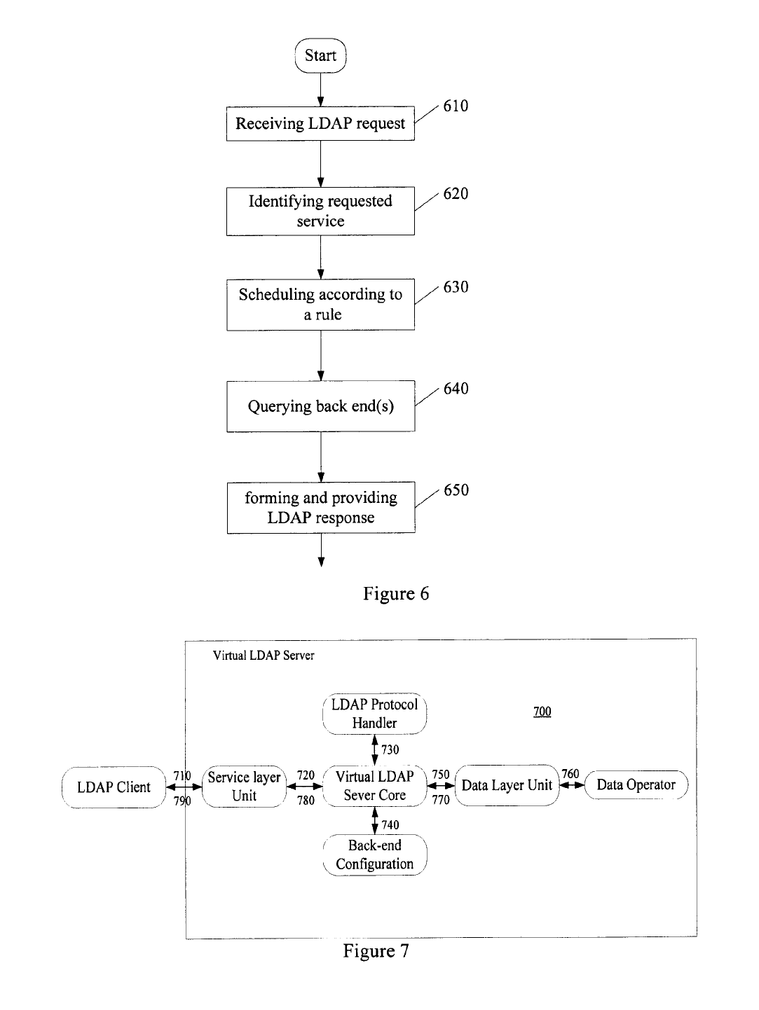

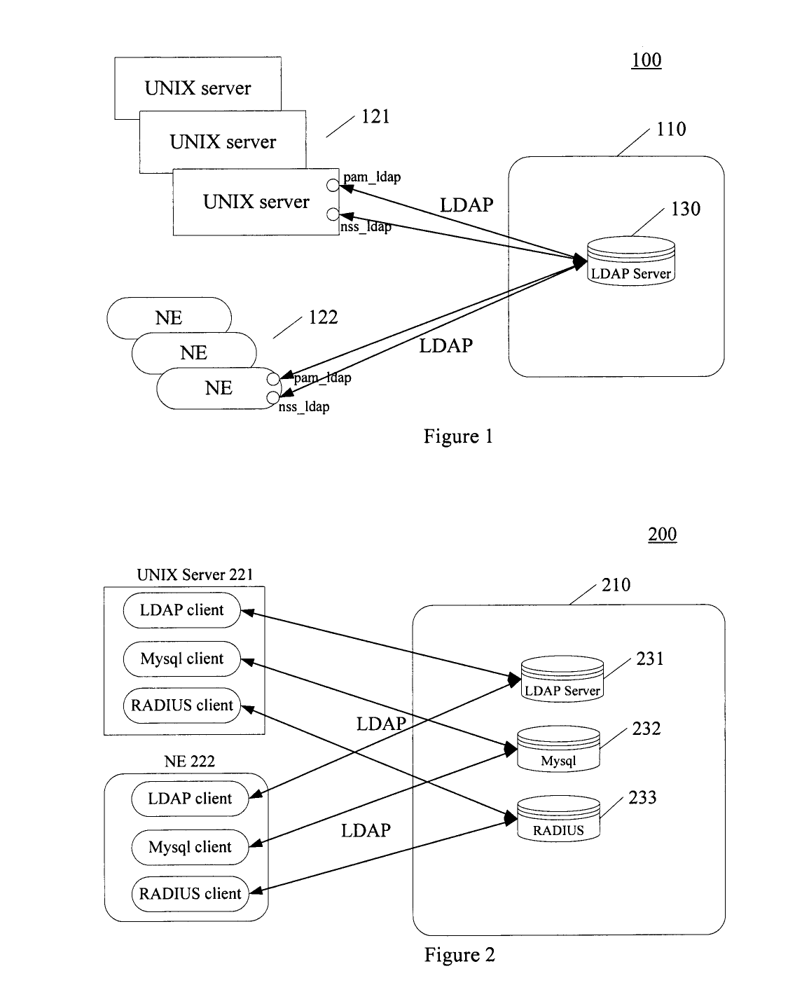

FIG. 1 illustrates an example of prior art system 100 for providing services. As shown in FIG. 1, the system 100 comprises a central server 110 and a plurality of UNIX servers 121 and NEs 122. The central server 110 comprises only one back-end, i.e. a LDAP server 130. In order to establish sessions with this LDAP server 130, UNIX

Servers 121 and NEs 122 have installed therein LDAP clients e.g. pam_ldap and nss_ldap that support LDAP protocol.

FIG. 2 illustrates another example of prior art system 200 for providing services via multiple back-ends. As shown in FIG. 2, the system 200 also comprises a central server 210 and a UNIX server 221 and a NE 222. But the central server 210 comprises multiple back-ends, including LDAP server 231, Mysql server 232 and RADIUS server 233. In order to establish sessions with different back-ends, the UNIX Server 221 and NE 222 have installed therein LDAP client, Mysql client and RADIUS client for supporting different protocols of the back-ends.

In this prior art system 200, since a LDAP client only supports LDAP protocol, it can only talk with LDAP server 231, not with Mysql server 232 or RADIUS server 233. As such, in case a UNIX server or a NE with only LDAP client installed, they will be prevented from utilizing user information or other resources stored in Mysql server 232 or RADIUS server 233. On other hand, even if installing multiple clients in UNIX servers or NEs, they will communicate with different back-ends individually, and the resources in multiple back-ends are not effectively integrated.

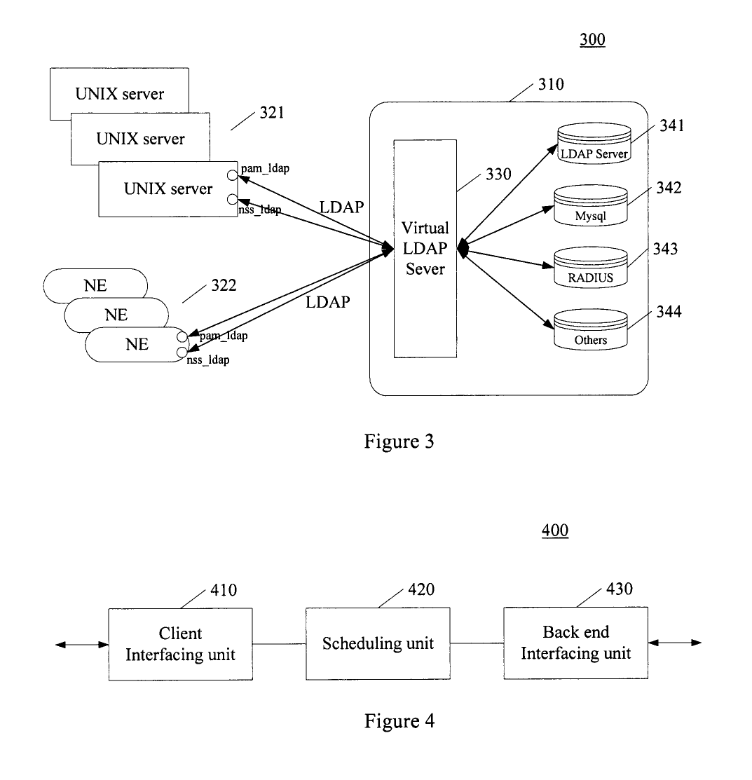

FIG. 3 illustrates a system 300 in which one embodiment of the present invention is implemented. As shown in FIG. 3, the system 300 comprises a central server 310 e.g. a security central server and a plurality of UNIX servers 321 and NEs 322. LDAP clients e.g. pam_ldap and nss_ldap are installed in UNIX servers 321 and NEs 322 to request services like authentication or authorization or other services, etc. The central server 310 comprises multiple back-ends, including LDAP server 341, Mysql server 342, RADIUS server 343 and other databases 344. As will be understood, although only pam_ldap and nss_ldap are illustrated, other types of LDAP clients may exist in the system.

According to an embodiment of the present invention, a device, designated as virtual LDAP server 330 in FIG. 3, is implemented between the UNIX servers 321 and NEs 322 and the back-ends 341, 342, 343, 344. The virtual LDAP server 330, on one side, communicates with pam_ldap or nss_ldap in UNIX servers 321 and NEs 322 using LDAP protocol, while on other side, communicates with back-ends 341, 342, 343, 344 using their corresponding protocols respectively. For example, the virtual LDAP server 330 connects to a LDAP server 341 via LDAP protocol, to a Mysql server 342 via a JDBC protocol, to a RADIUS server 343 via a RADIUS protocol, etc.

The virtual LDAP server 330 does not store user information or other similar data per se, but it appears as a LDAP server in a view of LDAP client. Meanwhile, for different back-ends, the virtual LDAP server may act as their respective clients. In one implementation, the virtual LDAP server 330 may receive a LDAP request from a UNIX server 321 or a NE 322 in LDAP protocol, and it may then talk with different back-ends in the central server 310 using respective back-end protocols to obtain one or more back-end responses for the LDAP request. The virtual LDAP server 330 may process the obtained back-end responses to form a suitable LDAP response for the LDAP request, and then send this LDAP response to the requesting UNIX server or NE.

This enables a LDAP client in e.g. a UNIX server or a NE to be serviced by not only LDAP server but also other back-ends, and the UNIX server or NE will not be impacted when back-ends in the central server are changed. Considering the huge number of LDAP clients in a system, introducing a virtual LDAP server will largely increase utilization of various back-ends existing in a central server. This also removes the need for installing other clients if the UNIX servers or NEs have installed a LDAP client.

As will be appreciated, although the virtual LDAP server 330 is illustrated in FIG. 3 as being integrated into the central server 310, it may be implemented as a stand-alone device.

FIG. 4 illustrates a block diagram of a virtual LDAP server 400 according to an embodiment of the present invention. The virtual LDAP server 400 enables to provide a mechanism to connect a LDAP client to different types of back-ends in a central server and allows two or more back-ends to cooperate to provide services, e.g. authentication or authorization or other services, to a LDAP client.

As shown in FIG. 4, the virtual LDAP server 400 may comprise a LDAP client interfacing unit 410, a back-end scheduling unit 420 and a back-end interfacing unit 430, which are operatively coupled together.

The LDAP interfacing unit 410 may receive a LDAP request for accessing a service from a LDAP client and provide a LDAP response to the LDAP client. The LDAP interfacing unit 410 connects with LDAP clients using LDAP protocol, which make the virtual LDAP server 400 appear as a ‘real’ LDAP server for LDAP clients. The type of LDAP clients may be, for example, pam_ldap or nss_ldap.

The back-end scheduling unit 420 may identify the requested service from the LDAP request. In one implementation, when the back-end scheduling unit 420 receives a LDAP request transferred by the LDAP interfacing unit 410, it may analyze the LDAP request to determine what service is requested. As an example, if the LDAP request is a “Bind” operation request, the service may be identified as “authentication”. This identification may be based on for example, RFC 2251. Or alternatively, it may be based on a keyword in the request, or based on a list recoding correspondences between requests and services.

The back-end scheduling unit 420 may schedule one or more back-ends to provide service according to a rule predefined for the requested service, and this rule indicates which back-end(s) are to be used for the requested service. Preferably, the rule further specifies schedule logics, including operation logic and optionally operation order to be followed by each scheduled back-end in order to better handle the requested service. More preferably, the rule indicates mapping relations between services and back-end requests. As used herein, the term “back-end request” is to be broadly interpreted to include any request or the like for establishing session with or connecting to a back-end for requesting or obtaining a certain service and a back-end request is compliance with corresponding back-end protocol. In one implementation, a rule may be maintained in a file named e.g. logic.VLS. Examples of the rule are described hereinafter.

For example, if the requested service is identified as “authentication”, then the rule may be:

If service==“auth” then;
Mysql: “username” and “password”,

and
File: “username” and “password”,

or
LDAP: “ou=People, o=oamplatform” and “userPassword” using “SSHA”.

The above rule indicates: if the service identified from a LDAP request is “authentication”, Mysql server and File with e.g. path: /opt/config/files/data.xml as well as possibly LDAP server are to be used for this service. The rule then specifies schedule logics for these back-ends, which are: both Mysql server and File being queried first to retrieve values of attributes or elements “username” and “password” for the purpose of authentication since an ‘AND’ operator is used here, and a response “true” will be returned if authentications via Mysql server and File are both passed; in case neither of the two authentications is passed, LDAP server being queried using attributes defined therein.

As another example, if the identified service is “get Login Warning”, then the rule may be:

If service==“getLoginWarning” then;
Mysql: “loginwarning”.

This rule indicate: Mysql server is to be used for this service and the schedule logic is to query Mysql server to retrieve value of attribute “loginwarning” and then return the value back.

The benefit is obvious since a flexible combination of back-ends or change of back-ends in connection with a given service may be achieved by easily modifying the rule. For example, if a new requirement is to get e.g. login warning information from a LDAP server or a File, but not from Mysql server, only modification to a rule in the file logic.VLS is needed. As such, when a new back-end is added in the central server, it may be incorporated to provide service by defining it in a new rule or introducing it in an old rule. Preferably, the rule will be updated manually or automatically when back-ends are added in or removed from the central server.

The back-end interfacing unit 430 may query the scheduled back-ends with respective back-end requests according to the rule and obtain respective back-end responses. According to an embodiment, the back-end requests for the scheduled back-ends are generated based on the rule.
For example, as in the case of “auth” service, the rule may indicate:
Mysql: “username” and “password”, and
File: “username” and “password”.

In this case, if generating the back-end requests via pseudocode using JAVA language for example, a back-end request for File server may be e.g.:“File file=new File(”/opt/data/data.xml“); //then get the values of username and password element from a xml file” and a back-end request in JDBC protocol for Mysql server may be e.g.:

Connection con=DriverManager.getConnection(url, “admin”, “”);

Statement stmt=con.createStatement( );

ResultSet rs=stmt.executeQuery(“SELECT username, password FROM user”).

As will be understood, in other implementations, a back-end request may be generated in other forms that are compliance with a corresponding back-end protocol.

Preferably, the generation is based on operation logics indicated in the rule and the query is performed in the order indicated in the rule.

The back-end scheduling unit 420 may form a LDAP response based on the obtained back-end responses. According to an embodiment, if the obtained response is just a LDAP response, the back-end scheduling unit 420 may transfer this LDAP response to the LDAP client interfacing unit 410 to send to the requesting LDAP client. If the obtained back-end responses are from other back-ends or from a number of back-ends, the back-end scheduling unit 420 may process these back-end responses to form a LDAP response. For example, the back-end scheduling unit 420 may combine information in different back-end responses or remove duplicated information from these back-end responses to form a suitable LDAP response for the LDAP client.

As such, a LDAP client may request services from a central server even if this central server comprises no LDAP server, and the LDAP client may utilize user information or other resources in other back-ends than LDAP server.

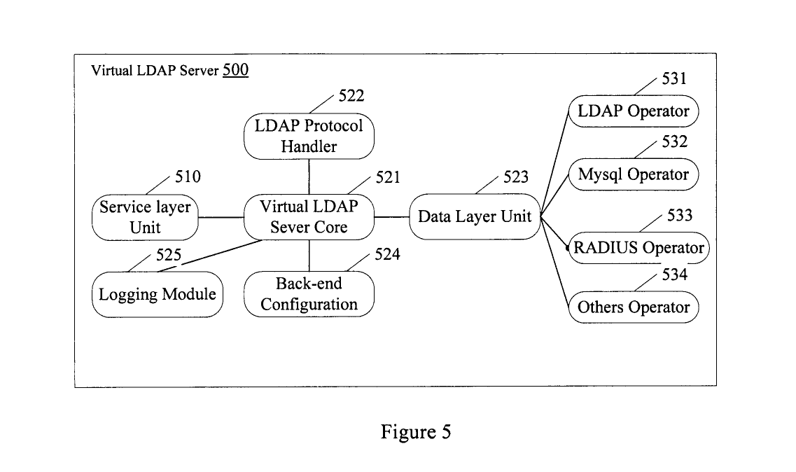

FIG. 5 illustrates an exemplary implementation of a virtual LDAP server 500 according to an embodiment of the present invention, which shows a high level design of the Virtual LDAP server.

As illustrated, the virtual LDAP server 500 comprises a service layer unit 510, a virtual LDAP server core 521, a LDAP protocol handler 522, a data layer unit 523 and back-end operators such as LDAP operator 531, Mysql operator 532, RADIUS operator 533 and other possible operators 534, which are operatively coupled together.

The service layer unit 510 may interface with a LDAP client and functions as a LDAP client interfacing unit. The service layer unit 510 may receive requests from a LDAP client e.g. nss_ldap and pam_ldap, for accessing services in a central server and send responses to requesting LDAP client on e.g. port 389. The service layer unit 510 supports LDAP protocol.

In this embodiment, the virtual LDAP server core 521, the LDAP protocol handler 522 and the data layer unit 523, as well as back-end configuration 524, work together to function as a back-end scheduling unit.

The virtual LDAP server core 521 couples with the service layer unit 510, the LDAP protocol handler 522 and the data layer unit 523, and distributes work flows among them. The virtual LDAP server core 521 may initialize and maintain a back-end configuration 524 that indicates the configuration of back-ends in the central server. The back-end configuration 524 comprises definition of back-ends, such as IP address, hostname, port number and so on. For example, the definition may be defined in e.g. a definition.VLS file like below:

[Mysql]

Hostname=localhost

Ip=192.168.1.1

Port=7788

database=mydata

user=Mysql

password=foo

. . .

[RADIUS]

Hostname=zcyds333

Ip=192.168.1.100

Port=444

. . .

[LDAP]

Hostname=zcyds344

Ip=192.168.1.111

Port=369

BaseDN=o=oamplatform

user=cn=directory manager

password=foo

. . .

[File]

Location=/opt/config/files/data.xml

This definition may be used to e.g. address or access respective back-ends.

The back-end configuration 524 may also comprise rules as described above that enable a number of back-ends to work together smoothly.

The virtual LDAP server core 521 may instruct the LDAP protocol handler 522 to identify the requested service from a LDAP request upon receipt of the LDAP request from the service layer unit 510. When being notified of the service that is requested, the virtual LDAP server core 521 may look up a rule in the back-end configuration for this requested service, and distribute the rule to the data layer unit 523 for scheduling back-ends to provide service. The virtual LDAP server core 521 may receive responses from the data layer unit 523, and if the responses are LDAP response, it directly transfers the responses to the service layer unit 510, otherwise, it will call the LDAP protocol handler 522 to transform the responses to LDAP responses.

The LDAP protocol handler 522 may identify the requested service based on the LDAP request. In one implementation, the LDAP protocol handler 522 may further get parameters related to the service from the LDAP request. In this case, the LDAP protocol handler 522 transforms the LDAP request to an action that indicates both identified service and the related parameters. For example, it may get parameters like username “administrator” and password “foo” from an authentication LDAP request, then the LDAP request may be transformed to an action like “auth” with username “administrator” and password “foo”. Similarly, the LDAP protocol handler 522 may transform a change password LDAP request to an action like “changepw” for username “administrator” with new password “foo2”. The LDAP protocol handler 522 will then notify the virtual LDAP server core 521 of the actions.

Then, the virtual LDAP server core 521 may retrieve a rule based on service identified in the notified action, and transfer the rule together with related parameters to the data layer unit 523.

The data layer unit 523 may receive a rule from the virtual LDAP server core 521 and schedule one or more back-ends according to the rule. Preferably, the data layer unit 523 may determine from the rule which back-ends will be involved and optionally their operation logics and/or operation order, i.e. how they will act, to provide the requested service. In one implementation, the data layer unit 523 may generate back-end request for each scheduled back-end in view of the rule and call a respective back-end operator to query with the back-end request accordingly. If related parameters of the requested service are received, generation of back-end request may further based on these parameters.

As an example, assuming the action is “Changepw” for username “test” with new password “foo”, and a rule for this action is predefined in the logic.VLS as:

If action==“Changepw” then;

LDAP: “ou=People, o=oamplatform” and “userPassword” using “SSHA”.

The data layer unit 523 may receive this rule and parameters of username “test” and new password “foo” from the virtual LDAP server core 521. The data layer unit 523 may determine from the rule that for this action “Changepw”, only LDAP server will be used. In this example, the rule “LDAP:”ou=People, o=oamplatform” and “userPassword” using “SSHA” describes the operation logic for performing this action, where the Distinguish Name (DN) that is to be changed in LDAP server is “userPassword” attribute of object “uid=test, ou=People, o=oamplatform”, and the password will be encrypted using SSHA. The data layer unit 523 will then call a LDAP operator to change the password in LDAP server. Optionally, the data layer unit 532 may generate e.g. a changepw LDAP request based on the rule and the received parameters and send it to the operator.

The data layer unit 523 may also be responsible for processing the responses from back-ends. For example, in case of an authentication request, the data layer unit 523 will compare the parameters ‘username’ and ‘password’ derived from the LDAP request with the ones in back-end response and then return result of authentication, i.e. true or false to the virtual LDAP server core 521. If duplicated information e.g. name exists in different back-end responses, the data layer unit 523 will remove redundant ones.

The back-ends operators may function as a back-end interfacing unit. It may follow instructions from the data layer unit 523 and query back-ends accordingly. This may need definition of back-ends as stored in the back-end configuration. As shown in FIG. 5, the back-ends operators include LDAP Operator 531 operating to communicate with the LDAP server through LDAP protocol, Mysql Operator 532 operating to communicate with Mysql server through JDBC, RADIUS Operator 533 operating to communicate with RADIUS server through RADIUS and other operators 534 operating to communicate with other servers. The back-end operators may receive back-end request generated by the data layer unit 523 for query back-ends. Alternatively, it may generate back-end request as instructed by the data layer unit 523.

As will be appreciated, the present invention is not limited to LDAP server, Mysql server and RADIUS server. If there are other types of back-ends, their corresponding operators may be installed in the virtual LDAP server so as to support sessions with them. In case a new type of back-end is introduced, a corresponding operator may be added in the virtual LDAP server. This will make it easy to extend or reduce the back-ends in the central server without impact on clients.

Preferably, the virtual LDAP server 500 may further comprise a Logging module 525. Since any operation about security is supposed to be recorded somewhere, this logging module 525 may write the security message in log files.

With help of such a virtual LDAP server, LDAP clients using LDAP protocol can talk with different types of back-ends or databases, and any changes of back-ends will be hidden from the clients. This allows easily incorporating new or different types of back-ends in a central server to provide services.

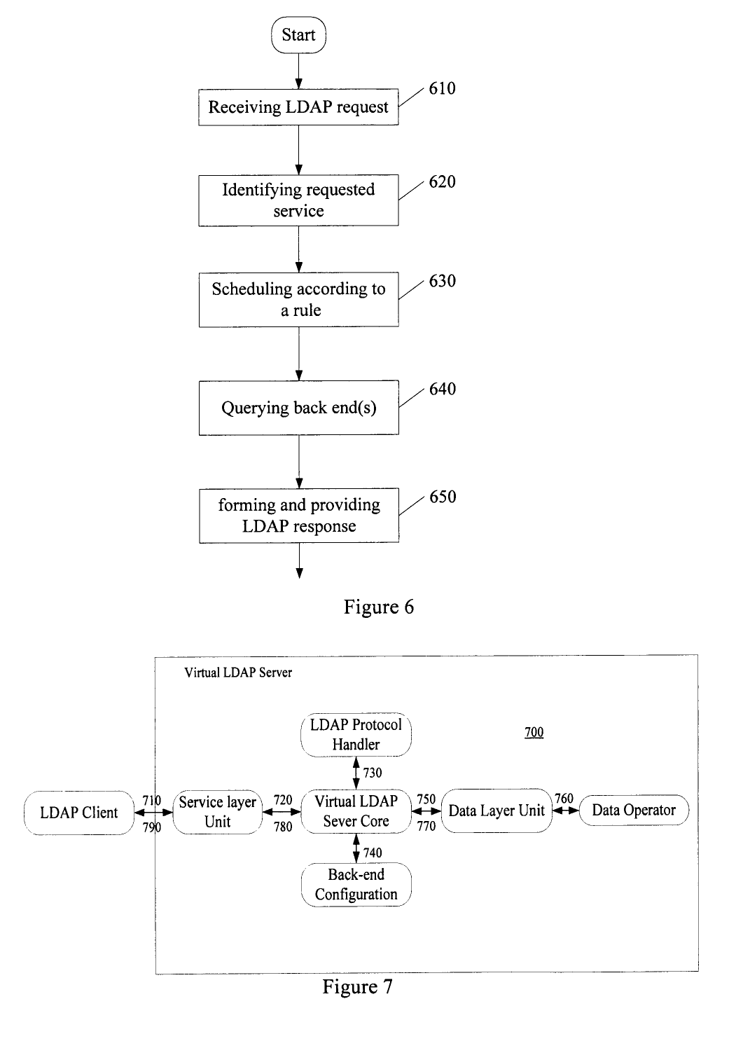

FIG. 6 illustrates a flow chart of a method 600 according to an embodiment of the present invention. This method 600 is for providing services for a LDAP client from a central server with multiple back-ends.

As illustrated, a LDAP request for accessing a service is received from the LDAP client in step 610. This LDAP request may be sent by e.g. nss_ldap or pam_ldap for requesting authentication or authorization or other services.

The requested service is identified from the LDAP request in step 620. For example, the identified service may be authentication, authorization, change password, or get Login Warning etc. Preferably, parameters associated with the service are also derived from this LDAP request, such as user name and password for service of authentication, user name and new password for service of change password, etc.

One or more back-ends are scheduled to provide service according to a rule predefined for the requested service in step 630, the rule indicating which back-end(s) are to be used for the requested service. Preferably, the rule further indicates schedule logics for scheduling the back-ends, including operation logics of each scheduled back-end and their operation order. The rule may be updated to adapt to changes of back-ends in the central server. Alternatively, a rule may be redefined, added or removed as required.

The scheduled one or more back-end(s) are queried according to the rule in order to obtain back-end responses for the requested service in step 640. Preferably, a back-end request for each scheduled back-end is generated based on the rule and optionally related parameters, if any.

A LDAP response is formed based on the obtained back-end responses and provided to the LDAP client in step 650.

FIG. 7 illustrates a flow chart of a method performed by a virtual LDAP server as shown in Figure 5.

In step 710, a Service Layer unit receives a LDAP request from a LDAP client, e.g. nss_ldap and pam_ldap, and in step 720, it distributes this request to a virtual LDAP service core.

After getting this request, in step 730, the virtual LDAP server core calls in step 730 the LDAP Protocol Handler to identify the service, e.g. transform this request to corresponding action. Being notified the service or action, in step 740, the virtual LDAP server core gets back-end configuration and retrieves a rule predefined for the service from the back-end configuration. In step 750, the virtual LDAP server core sends the rule together with related parameters, if any, to the data layer unit.

The data layer unit determines from the rule which back-ends will be scheduled and how they will act. In step 760, the data layer unit calls corresponding back-ends operators to query the scheduled back-ends. The data layer unit collects responses of different back-ends through the called back-end operators and processes the responses.

In step 770, the virtual LDAP server core gets the response from the data layer unit, and if needed, it calls the LDAP protocol handler to transform the response to a LDAP response.

In step 780, the service layer unit gets the LDAP response from virtual LDAP server core and transmits it to the LDAP client.

As will be appreciated by one of skill in the art, the present invention may be embodied as a method, device, system, or computer program product. Accordingly, the present invention may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, the present invention may take the form of a computer program product on a computer-usable storage medium having computer-usable program code embodied in the medium.

The present invention has been described with reference to flowchart illustrations and/or block diagrams of methods, device (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing device to produce a machine, such that the instructions, which execute via the processor of the computer or other programmable data processing device, create means for implementing the functions/acts specified in the flowchart and/or block diagram block or blocks.

Although specific embodiments have been illustrated and described herein, those of ordinary skill in the art appreciate that any arrangement which is calculated to achieve the same purpose may be substituted for the specific embodiments shown and that the invention has other applications in other environments. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The mere fact that certain measures are recited in mutually different dependent claims does not indicate that a combination of these measures cannot be used to advantage. This application is intended to cover any adaptations or variations of the present invention. The following claims are in no way intended to limit the scope of the invention to the specific embodiments described herein.

1-14. (canceled)

15. A device for providing service to a Lightweight Directory Access Protocol (LDAP) client from a central server with multiple back-ends, the device comprising:
a LDAP interfacing circuit configured to receive a LDAP request for accessing a service from the LDAP client;
a back-end scheduling circuit configured to:
identify the requested service from the LDAP request;
schedule one or more back-ends to provide service according to a rule predefined for the requested service, the rule indicating which back-ends are to be used for the requested service;
a back-end interfacing circuit configured to query the scheduled back-ends with respective back-end requests according to the rule and obtain back-end responses;
wherein the back-end scheduling is further configured to form a LDAP response to the LDAP client based on the obtained back-end responses;
wherein the LDAP interfacing circuit configured to provide the formed LDAP response to the LDAP client.

16. The device of claim 15, wherein the rule is updated to adapt to changes of back-ends in the central server.

17. The device of claim 15, wherein the rule further indicates mappings relationships between the requested service and respective back-end requests.

18. The device of claim 17, wherein the back-end interfacing circuit is configured to generate the back-end request for each scheduled back-end based on the mapping relationships.

19. The device of claim 15, wherein the rule further indicates operation logic to be followed by the scheduled back-ends.

20. The device of claim 15, wherein the back-end scheduling circuit is configured to perform at least one of:
combine information from the obtained back-end responses;
remove duplicated information in the obtained back-end responses.

21. The device of claim 15, wherein the device comprises a portion of a Central Server.

22. A method of providing services for a Lightweight Directory Access Protocol (LDAP) client from a central server with multiple back-ends, the method comprising:
receiving a LDAP request for accessing a service from the LDAP client;
identifying the requested service from the LDAP request;
scheduling one or more back-ends to provide service according to a rule predefined for the requested service, the rule indicating which back-ends are to be used for the requested service;
querying the scheduled back-ends with respective back-end requests according to the rule to obtain back-end responses;
forming a LDAP response based on the obtained back-end responses;
providing the formed LDAP response to the LDAP client.

23. The method of claim 22, further comprising updating the rule to adapt to changes of back-ends in the central server.

24. The method of claim 22, wherein the rule further indicates mapping relationships between the requested service and respective back-end requests.

25. The method of claim 24, wherein the querying comprises generating a back-end request for each scheduled back-end based on the mapping relationships.

26. The method of claim 22, wherein the rule further indicates operation logic to be followed by the scheduled back-ends.

27. The method of claim 22, wherein the forming the LDAP comprises at least one of:
combining information from the obtained back-end responses;
removing duplicated information in the obtained back-end responses.

28. A computer program product stored in a non-transitory computer readable medium for providing services for a Lightweight Directory Access Protocol (LDAP) client from a central server with multiple back-ends, the computer program product comprising software instructions which, when run on a computer, causes the computer to:
receive a LDAP request for accessing a service from the LDAP client;
identify the requested service from the LDAP request;
schedule one or more back-ends to provide service according to a rule predefined for the requested service, the rule indicating which back-ends are to be used for the requested service;
query the scheduled back-ends with respective back-end requests according to the rule to obtain back-end responses;
form a LDAP response based on the obtained back-end responses;
provide the formed LDAP response to the LDAP client.
